(19) United States
(12) Patent Application Publication
(10) Pub. No.: US 2007/0008858 A1
(43) Pub. Date: Jan. 11, 2007

(54) Optical pickup and optical disc apparatus

(75) Inventor: Hiroaki Yukawa, Shizuoka (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/455,629

(22) Filed: Jun. 19, 2006

(30) Foreign Application Priority Data
Jun. 22, 2005 (JP) JP2005-182512

(51) Int. Cl. G11B 7/00

(52) U.S. Cl. 369/112.16; 369/13.53; 369/110.01

(57) ABSTRACT

There is provided an optical pickup for recording or reproducing an information signal on/from a plurality of optical discs, each including a protective substrate having a different thickness for protecting a signal recording surface. The optical pickup includes: a light source section emitting a light beam having a predetermined wavelength; a first and second objective lens collecting light on the signal recording surface while reducing a spherical aberration due to a protective substrate having a first and second thickness, respectively; a polarization switching section adapted to switch a polarized state of the light beam emitted from the light source section; and a polarization beam splitter adapted to guide the light beam to either the first objective lens or the second objective lens depending on the polarized state of the light beam switched by the polarization switching section.

### BACKGROUND OF THE INVENTION

1. Field of the Invention

The present invention relates to an optical pickup and an optical disc apparatus, which record or reproduce an information signal to/from an optical disc on which information recording and reproducing are optically performed, such as a magneto-optical disc or a phase-change type optical disc.

2. Description of the Related Art

With the increase in density of an information recording medium such as an optical disc, there are provided formats, which use light sources having various wavelengths and include protective substrates having various thicknesses. An optical pickup having compatibility with the plurality of types of optical discs is desired.

In practice, an optical pickup having compatibility, which allows an information signal to be recorded on and reproduced from optical discs in different formats using different wavelengths and including protective substrates having different thicknesses, has recently been known. For example, as an optical pickup having compatibility with optical discs in different formats, there is the one which includes different optical systems and switches the optical system for each format. However, such an optical pickup requires a switching mechanism between a plurality of types of optical systems and therefore has a complicated structure, resulting in increase in cost. Moreover, since the switching mechanism has a large size, it is difficult to reduce the size of the optical pickup.

Thus, in an optical pickup of related art such as disclosed in Japanese Patent Application Publication Number H09-147405, by radiating light beams having different wavelengths on optical discs including protective substrates having different thicknesses, specifically, by using a light beam having a different wavelength for each format, the compatibility with optical discs in a plurality of formats is realized. At the same time, optical components are shared so as to reduce the size of the optical pickup.

### SUMMARY OF THE INVENTION

In the optical pickups of related art described above, however, it was difficult to realize the compatibility with a plurality of optical discs, each using a light beam having the same wavelength and including a protective substrate having a different thickness.

Accordingly, it is desirable to provide an optical pickup and/or an optical disc apparatus, capable of recording and reproducing information to/from a plurality of types of optical discs, each including a protective substrate having a different thickness while appropriately correcting a spherical aberration, thereby achieving reduction in size by sharing optical components. The present invention is achieved in view of the above issues.

In an embodiment of the present invention, there is provided an optical pickup and/or an optical disc apparatus including such an optical pickup for recording or reproducing an information signal on/from a plurality of optical discs, each including a protective substrate having a different thickness for protecting a signal recording surface. The optical pickup includes: a light source section adapted to emit a light beam having a predetermined wavelength; a first objective lens adapted to collect light on the signal recording surface while reducing a spherical aberration due to a protective substrate having a first thickness; a second objective lens adapted to collect light on the signal recording surface while reducing a spherical aberration due to a protective substrate having a second thickness; a polarization switching section adapted to switch a polarized state of the light beam emitted from the light source section; and a polarization beam splitter adapted to guide the light beam to either the first objective lens or the second objective lens depending on the polarized state of the light beam switched by the polarization switching section.

The optical pickup and/or the optical disc apparatus according to the present embodiment uses the light beam emitted from the light source section to appropriately correct the spherical aberration for the plurality of types of optical discs, each including the protective substrate having a different thickness for reading and writing a signal. In addition, the optical components can be shared. Therefore, the configuration can be simplified and reduced in size, thereby reducing manufacture cost.

### BRIEF DESCRIPTION OF THE DRAWINGS

FIG. 1 is a block circuit diagram showing a configuration of an optical disc apparatus using an optical pickup according to an embodiment of the present invention;

FIG. 2 is a ray diagram for explaining an optical system of the optical pickup according to an embodiment of the present invention;

FIG. 3 is a ray diagram for explaining an optical path and a polarized state of a light beam in the optical pickup, according to an embodiment of the present invention, for each optical disc; and

FIG. 4 is a ray diagram for explaining an optical path and a polarized state of a light beam in another example of the optical pickup according to an embodiment of the present invention for each optical disc.

### DETAILED DESCRIPTION OF EMBODIMENTS

Hereinafter, an optical disc apparatus using an optical pickup according to an embodiment of the present invention will be described with reference to the drawings.

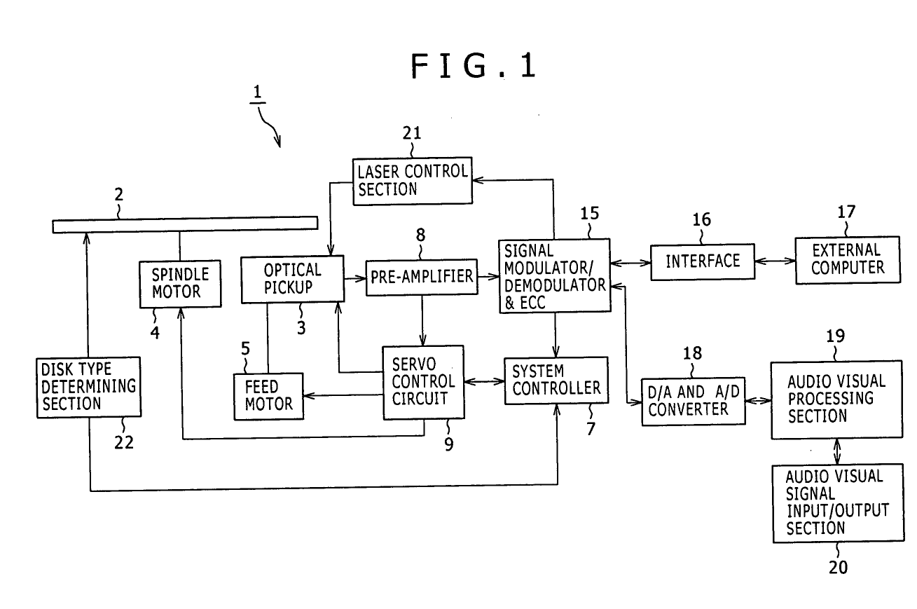

As shown in FIG. 1, an optical disc apparatus 1 according to the present embodiment includes: an optical pickup 3 for recording and reproducing information to/from an optical disc 2; a spindle motor 4 serving as driver means for rotatably operating the optical disc 2; and a feed motor 5 for moving the optical pickup 3 in a radial direction of the optical disc 2. The optical disc apparatus 1 has realized the compatibility that allows information to be recorded and/or reproduced on/from a plurality of types of optical discs in different formats.

The optical disc 2 that can be used in this embodiment is, for example, an optical disc such as a CD (Compact Disc), a DVD (Digital Versatile Disc), a CD-R (Recordable) and a DVD-R (Recordable) on which information is recordably added, and a CD-RW (ReWritable), a DVD-RW (ReWritable) and a DVD+RW (ReWritable) to which information is rewritable, an optical disc using a semiconductor laser having a short emission wavelength of about 405 nm (blue-violet laser beam) to enable high-density recording, a magneto-optical disc and the like.

In particular, as four types of optical discs from/on which information is reproduced or recorded by the optical disc apparatus 1 below, a first optical disc 11 including a protective substrate having a thickness of 0.1 mm and using a light beam having a wavelength of about 405 nm as recording/reproducing light to enable high-density recording, a second optical disc 12 including a protective substrate having a thickness of 0.6 mm and using a light beam having a wavelength of about 405 nm as recording/reproducing light to enable high-density recording, a third optical disc 13 including a protective substrate at a thickness of 0.6 mm and using a light beam having a wavelength of about 655 nm as recording/reproducing light, and a fourth optical disc 14 including a protective substrate at a thickness of 1.2 mm and using a light beam having a wavelength of about 785 nm as recording/reproducing light are used in the following description.

In the optical disc apparatus 1, the spindle motor 4 and the feed motor 5 are controlled to be driven in accordance with the type of disc by a servo control circuit 9 which is controlled based on an instruction from a system controller 7 also serving as disc type determination means. For example, the spindle motor 4 and the feed motor 5 are driven at a predetermined number of revolutions in accordance with any of the first optical disc 11, the second optical disc 12, the third optical disc 13, and the fourth optical disc 14.

The optical pickup 3 includes an optical system having compatibility with a plurality of types of formats. The optical pickup 3 emits a light beam having a different wavelength to a recording layer of an optical disc in a different format and detects reflected light of the light beam from the recording layer. The optical pickup 3 supplies a signal corresponding to each light beam to a pre-amplifier section 8 from the detected reflected light.

An output from the pre-amplifier section 8 is sent to a signal modulator/demodulator and error correction code block (hereinafter, referred to as a signal modulation/demodulation & ECC block) 15. The signal modulation/demodulation & ECC block 15 performs the modulation and demodulation of a signal and the addition of an ECC (error correction code). The optical pickup 3 emits a light beam onto a recording layer of the optical disc 2 which rotates in accordance with an instruction from the signal modulation/demodulation & ECC block 25.

The pre-amplifier section 8 is configured to generate a focus error signal, a tracking error signal, an RF signal and the like based on a signal corresponding to the light beam detected in a different manner for each format. In accordance with the type of the optical disc 2 corresponding to a recording or reproducing target medium, a predetermined process such as demodulation and an error correction process is performed based the format of the optical disc 2.

If, for example, a recorded signal demodulated by the signal modulation/demodulation & ECC block 15 is for data storage of a computer, the recorded signal is passed to an external computer 17 through an interface 16. As a result, the external computer 17 or the like can receive the signal recorded on the optical disc 2 as a reproduced signal.

If the recorded signal demodulated by the signal modulation/demodulation & ECC block 15 is for audio visual, the recorded signal is subjected to digital-to-analog conversion by the D/A converting section of a D/A and A/D converter 18 to be then supplied to an audio visual processing section 19. Then, the recorded signal is subjected to an audio visual processing in the audio visual processing section 19 to be passed to an external imaging projector (not shown) or the like through an audio visual signal input/output section 20.

In the optical pickup 3, for example, the control of the feed motor 5 for moving the optical pickup 3 to a predetermined recording track on the optical disc 2, the control of the spindle motor 4, the control of the focusing-direction and tracking-direction driving of a biaxial actuator for holding the objective lens serving as light collecting means in the optical pickup 3 are performed by the servo control circuit 9.

A laser control section 21 controls a laser light source of the optical pickup 3. In this specific example, in particular, the laser control section 21 controls the laser light source to vary output power between a recording mode and a reproducing mode. The laser control section 21 also controls the laser light source to vary the output power in accordance with the type of the optical disc 2. The laser control section 21 switches the laser light source of the optical pickup 3 in accordance with the type of the optical disc 2 detected by the disc type determining section 22.

The disc type determining section 22 can detect a different format of the optical disc 2 based on a difference in surface reflectance, shape, profile or the like between the first to fourth optical discs 11 to 14.

Each of the blocks constituting the optical disc apparatus 1 is configured to enable signal processing based on a specification of the optical disc to be loaded, in accordance with the result of detection in the disc type determining section 22.

The system controller 7 determines the type of the optical disc 2 based on the result of detection sent from the disc type determining section 22. As a technique of determining the type of the optical disc, if the optical disc is housed within a cartridge, a technique of providing a detection hole through the cartridge and using a contact detection sensor or a push switch to detect the type of the optical disc is given as an example. For determination of a recording layer in the same optical disc, a method of determining a recording layer for which recording/reproducing is performed based on information in a Table Of Contents (TOC) recorded in a pre-mastered pit or groove on the innermost circumference of the optical disc can be used.

The servo control circuit 9 is controlled by the system controller 7 to control a focal length in the optical pickup 3, that is, the position of a collimator lens 35 described below in accordance with the result of determination of the disc type determining section 22. The servo control circuit 9 detects, for example, a relative position between the optical pickup 3 and the optical disc 2 (including the case where the position is detected based on an address signal recorded on the optical disc 2) to determine a recording area to/from which an information signal is recorded or reproduced.

The optical disc apparatus 1 configured as described above rotatably drives the optical disc 2 with the spindle motor 4, controls the driving of the feed motor 5 in accordance with a control signal from the servo control circuit 9, and moves the optical pickup 3 to the position corresponding to a desired recording track on the optical disc 2, thereby recording/reproducing information on/from the optical disc 2.

Hereinafter, the above-described optical pickup 3 for recording/reproducing will be described in detail.

The optical pickup 3 performs recording and/or reproducing on/from a plurality of optical discs, each including a protective substrate having a different thickness for protecting a signal recording surface. Specifically, the description will be given, assuming that the optical pickup 3 records or reproduces an information signal on/from the first optical disc 11 and the second optical disc 12; the first optical disc 11 includes a first protective substrate having a first thickness of about 0.1 mm and uses a light beam having a first wavelength of about 405 nm as recording/reproducing light, and the second optical disc 12 includes a second protective substrate having a second thickness of about 0.6 mm and uses the light beam having the first wavelength of about 405 nm as recording/reproducing light.

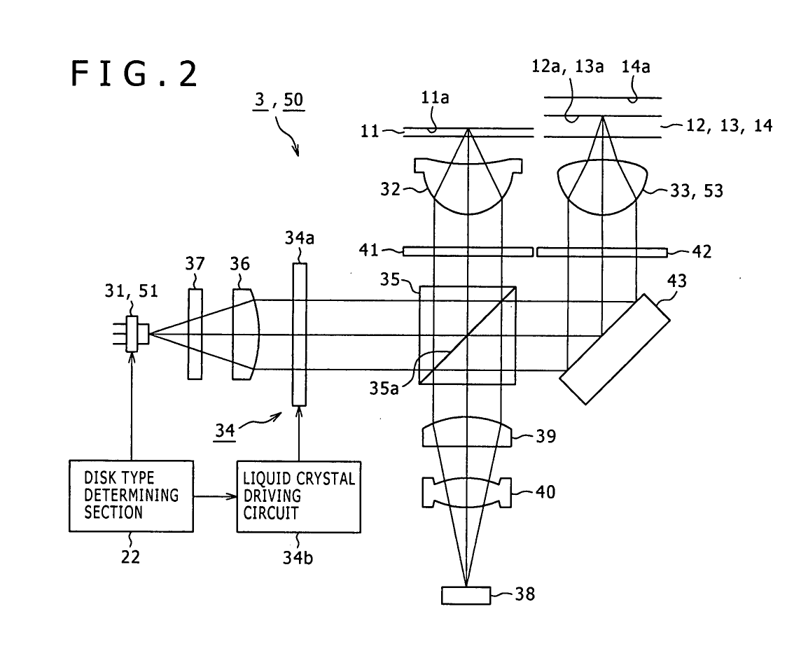

The optical pickup 3 according to another embodiment of the present invention includes, as illustrated in FIG. 2: a light source section 31 for emitting the light beam having the first wavelength of about 405 nm; a first objective lens 32 for collecting the light beam having the first wavelength on a signal recording surface 11a of the first optical disc 11 while reducing or eliminating a spherical aberration in accordance with the protective substrate having the first thickness; a second objective lens 33 for collecting the light beam having the first wavelength on a signal recording surface 12a of the second optical disc 12 while reducing or eliminating a spherical aberration in accordance with the protective substrate having the second thickness; a polarization switching section 34 for selectively switching a polarized state of the light beam emitted from the light source section 31; and a polarization beam splitter 35 for guiding the light beam to either the first or second objective lenses 32 and 33 based on the polarized state of the light beam, which is switched by the polarization switching section 34.

The optical pickup 3 also includes: a collimator lens 36 provided between the light source section 31 and the polarization switching section 34, for converting divergence angles of the light beams emitted from the light source section 31 to convert the light beams into approximately parallel light beams; a grating 37 provided between the light source section 31 and the collimator lens 36, for splitting the light beam into three beams composed of a 0-th order light beam and ±first order light beams so as to obtain a tracking error signal and the like; a photodetector 38 for receiving return light reflected by the signal recording surface; a condensing lens 39 provided between the polarization beam splitter 35 and the photodetector 38, for condensing the passing light beam on the photodetector 38; and a multi-lens 40 provided between the polarization beam splitter 35 and the photodetector 38, for generating an astigmatism to obtain a focusing error signal.

The optical pickup 3 further includes: a mirror 43 for reflecting the light beam passed through the polarization beam splitter 35 to change an optical path of the light beam so as to guide the light beam to the second objective lens 33; a first quarter-wavelength plate 41 provided between the polarization beam splitter 35 and the first objective lens 32 to impart a phase difference of a quarter wavelength to the light beam reflected by the polarization beam splitter 35; and a second quarter-wavelength plate 42 provided between the mirror 43 and the second objective lens 33 to impart a phase difference of a quarter wavelength to the light beam reflected by the mirror 43.

The light source section 31 emits a light beam having a predetermined wavelength, that is, a first wavelength to the first optical disc 11 or the second optical disc 12.

The first objective lens 32 has a first focal length to correspond to the light beam having the first wavelength and a numerical aperture of 0.85. For the first optical disc 11 including the first protective substrate having the first thickness, the first objective lens 32 collects the light beam having the first wavelength on the signal recording surface 11a while reducing or eliminating a spherical aberration in accordance with the first protective substrate.

On the light-incoming side of the first objective lens 32, a first aperture filter (not shown) serving as an aperture limiting element for limiting the aperture of the light beam incident on the first objective lens 32 is provided. The first aperture filter limits the numerical aperture of the passing light beam having the first wavelength to 0.85.

The second objective lens 33 has a second focal length to correspond to the light beam having the first wavelength and a numerical aperture of 0.65. For the second optical disc 12 including the second protective substrate having the second thickness, the second objective lens 33 collects the light beam having the first wavelength on the signal recording surface 12a while reducing or eliminating a spherical aberration in accordance with the second protective substrate.

On the light-incoming side of the second objective lens 33, a second aperture filter (not shown) serving as an aperture limiting element for limiting the aperture of the light beam incident on the second objective lens 33 is provided. The second aperture filter limits the numerical aperture of the passing light beam having the first wavelength to 0.65.

The polarization switching section 34 is composed of, for example, polarization switching liquid crystal 34a and a liquid crystal driving circuit 34b. The polarization switching section 34 selectively switches a polarized state of the passing light beam based on the type of disc detected by the disc type determining section 22. Specifically, when the loaded optical disc 2 is the first disc 11, the polarization switching liquid crystal 34a of the polarization switching section 34 is turned ON by the liquid crystal driving circuit 34b to convert the polarized state of the light beam having the first wavelength from a S-wave to a P-wave so as to allow the light beam having the first wavelength to outgo. On the other hand, when the loaded disc 2 is the second disc 12, the polarization switching liquid crystal 34a of the polarization switching section 34 is made to remain in an OFF state by the liquid crystal driving circuit 34b to allow the passing light beam having the first wavelength to outgo still as the S-wave.

Although the polarization switching liquid crystal 34a and the liquid crystal driving circuit 34b are used as the polarization switching section 34 in this embodiment, the polarization switching section 34 is not limited thereto. For example, the polarization switching section 34 may be composed of polarized state converting means such as a half-wavelength plate and driver means for inserting or removing the polarized state converting means from the optical path.

Moreover, the polarized state of the light beam incident on the polarization switching liquid crystal 34a, that is, the light beam emitted from the light source section 31 is described as the S-wave; the polarized state of the light beam is converted into the P-wave when the polarization switching liquid crystal 34a is turned ON, whereas the polarized state of the light beam remains unchanged as the S-wave when the polarization switching liquid crystal 34a is turned OFF. However, the polarization switching is not limited thereto. The polarized state of the light beam incident on the polarization switching liquid crystal 34a, that is, the light beam emitted from the light source section 31 may be the P-wave. In this case, the polarized state of the light beam is converted into the S-wave when the polarization switching liquid crystal 34a is turned ON, whereas the polarized state of the light beam remains unchanged as the P-wave when the polarization switching liquid crystal 34a is turned OFF. In this case, the above-described switching operation, that is, the ON/OFF control may be reversed.

The polarization beam splitter 35 includes a splitter face 35a, on which a thin optical film having such polarization dependency that transmits the almost full amount of the light beam having passed as the S-wave and reflects the almost full amount of the light beam having passed as the P-wave is formed.

The polarization beam splitter 35 can selectively guide the light beam toward the first objective lens 32 or the second objective lens 33, depending on the polarized state of the light beam switched by the polarization switching section 34. Specifically, the polarization beam splitter 35 reflects the light beam to guide the optical path of the light beam toward the first objective lens 32 when the incident light beam is the P-wave and transmits the light beam to guide the optical path of the light beam toward the second objective lens 33 when the incident light beam is the S-wave.

Although the polarization beam splitter 35 is configured to transmit the S-wave and to reflect the P-wave in this embodiment, the polarization beam splitter 35 is not limited thereto. For example, the polarization beam splitter 35 may also be configured to reflect the S-wave and to transmit the P-wave. In this case, the switching operation of the polarization switching section 34 described above, that is, the ON/OFF control may be reversed.

The polarization beam splitter 35 also splits the optical path of each return light of the light beam collected through the first objective lens 32 or the second objective lens 33, which is reflected off the optical disc, from the optical path of the incoming light beam emitted from the light source section 31 to guide the return light toward the photodetector 38. Specifically, the return light collected through the first objective lens 32 to be reflected off the optical disc is made to remain as the S-wave by the first quarter-wavelength plate 41 to be incident on the polarization beam splitter 35, as described below. Therefore, the return light is passed through the splitter face 35a to be guided toward the photodetector 38. On the other hand, the return light collected through the second objective lens 33 to be reflected off the optical disc is converted into the P-wave by the second quarter-wavelength plate 42 to be incident on the polarization beam splitter 35, as described below. Therefore, the return light is reflected by the splitter face 35a to be guided toward the photodetector 38.

The collimator lens 36 converts a divergent angle of each passing light beam having the first wavelength emitted from the light source section 31 to convert the light beams into approximately parallel light beams and then allows the approximately parallel light beams to output to the polarization switching liquid crystal 34a.

The photodetector 38 includes a photodetection device for receiving three light beams obtained by the splitting through the grating 37 and for detecting an astigmatism imparted by the multi-lens 40. In this manner, the photodetector 38 can detect various signals such as a tracking error signal and a focusing error signal in addition to the information signal.

The condensing lens 39 converts a divergent angle of the light beam guided by the polarization beam splitter 35 toward the photodetector 38 to focus the light beam on the photodetection device of the photodetector 38.

The first quarter-wavelength plate 41 imparts a phase difference of a quarter wavelength to the passing light beam. Specifically, the first quarter-wavelength plate 41 converts the incoming light beam from a linearly-polarized light beam (P-wave) to a circularly-polarized light beam and converts the outgoing light beam reflected off the optical disc from a circularly-polarized light beam to a linearly-polarized light beam (S-wave). By allowing the light beam to be passed through the first quarter-wavelength plate 41 twice, that is, before and after being incident on the optical disc on the optical path, the polarized state of the incoming light beam can be made different from that of the outgoing light beam.

The second quarter-wavelength plate 42 is provided on the optical path between the polarization beam splitter 35 and the second objective lens 33 and imparts a phase difference of a quarter wavelength to the passing light beam. Specifically, the second quarter-wavelength plate 42 converts the incoming light beam from a linearly-polarized light beam (S-wave) to a circularly-polarized light beam and converts the outgoing light beam reflected off the optical disc from a circularly-polarized light beam to a linearly-polarized light beam (P-wave). By allowing the light beam to be passed through the second quarter-wavelength plate 42 twice, that is, before and after being incident on the optical disc on the optical path, the polarized state of the incoming light beam can be made different from that of the outgoing light beam.

The first and the second objective lenses 32 and 33 are held by a lens holder (not shown). The lens holder includes: a biaxial actuator (not shown) for moving the first objective lens 32 and the second objective lens 33 held by the lens holder in a tracking direction as well as in a focusing direction; and an actuator driving circuit for driving the biaxial actuator based on a detected signal obtained by the disc type determining section 22 and a detected signal obtained by the photodetector 38. The biaxial actuator is controlled by the actuator driving circuit to move the first objective lens 32 and the second objective lens 33 in the tracking direction as well as in the focusing direction.

The optical pickup 3 configured as described above drives the first objective lens 32 or the second objective lens 33 based on the focusing servo signal and the tracking servo signal generated by the return light detected by the photodetector 38 to perform focus servo and tracking servo. The first objective lens 32 or the second objective lens 33 is driven to be moved to a focused focal point of the objective lens with respect to the recording face of the optical disc 2. As a result, the light beam is focused on the recording face of the optical disc 2 to record or reproduce information on/from the optical disc 2.

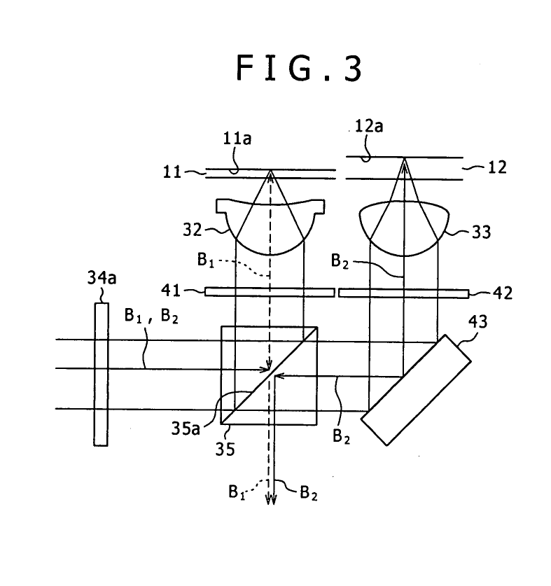

Next, the optical path of the light beam emitted from the light source section 31 in the optical pickup 3 will be described with reference to FIGS. 2 and 3. First, the optical path of the light beam having the first wavelength emitted to the first optical disc 11 will be described.

Based on a signal from the disc type determining section 22 which has determined that the optical disc 2 is the first optical disc 11, the light source section 31 emits the light beam having the first wavelength.

The light beam having the first wavelength emitted from the light source section 31 is split by the grating 37 into a plurality of light beams. Then, after divergent angles of the light beams are converted by the collimated lens, the light beams are converted into approximately parallel light beams to output to the polarization switching liquid crystal 34a.

After the light beam having the first wavelength incident on the polarization switching liquid crystal 34a is converted from the S-wave into the P-wave by the polarization switching liquid crystal 34a which is controlled to be turned ON by the liquid crystal driving circuit 34b based on the signal from the disc type determining section 22, the light beam outgoes toward the polarization beam splitter 35.

A light beam B1 having the first wavelength now converted into the P-wave by the polarization switching liquid crystal 34a is reflected by the polarization beam splitter 35. Then, the light beam B1 is converted into a circularly-polarized light beam by the first quarter-wavelength plate 41 to output to the first objective lens 32.

The light beam B1 having the first wavelength incident on the first objective lens 32 is collected on the signal recording surface 11a of the first optical disc 11 after its spherical aberration due to the first protective substrate having the first thickness is eliminated or substantially reduced by the first objective lens 32.

The light beam B1 collected on the first optical disc 11 is reflected by the signal recording surface 11a to be passed through the first objective lens 32. After being converted into the S-wave by the first quarter-wavelength plate 41, the light beam B1 outgoes toward the polarization beam splitter 35.

The light beam B1 having the first wavelength converted into the S-wave by the first quarter-wavelength plate 41 is passed through the polarization beam splitter 35 and emitted to the condensing lens 39.

After the divergent angle of the light beam having the first wavelength passed through the polarization beam splitter 35 is converted by the condensing lens 39 and the astigmatism for focus servo is imparted by the multi-lens 40, the light beam having the first wavelength is focused on the photodetection device of the photodetector 38.

Next, in the optical pickup 3, the optical path of the light beam having the first wavelength emitted to the second optical disc 12 will be described.

Based on a signal from the disc type determining section 22 which has determined that the optical disc 2 is the second optical disc 12, the light source section 31 emits the light beam having the first wavelength.

The light beam having the first wavelength emitted from the light source section 31 is split by the grating 37 into a plurality of light beams. Then, after the divergent angles are converted by the collimator lens 36, the light beams are converted into approximately parallel light beams and outputted to the polarization switching liquid crystal 34a.

The light beam having the first wavelength incident on the polarization switching liquid crystal 34a remains as the S-wave after being passed through the polarization switching liquid crystal 34a controlled by the liquid crystal driving circuit 34b based on the signal from the disc type determining section 22. Then, the light beam having the first wavelength is outputted to the polarization beam splitter 35.

A light beam B2, which is passed through the polarization switching liquid crystal 34a still as the S-wave, is then passed through the polarization beam splitter 35. Then, the light beam B2 is reflected by the mirror 43 to be converted into a circularly-polarized light beam by the second quarter-wavelength plate 42 so as to output to the second objective lens 33.

After the spherical aberration due to the second protective substrate having the second thickness is eliminated or substantially reduced by the second objective lens 33, the light beam B2 having the first wavelength incident on the second objective lens 33 is then condensed on the signal recording surface 12a of the second optical disc 12.

The light beam B2 collected on the second optical disc 12 is reflected by the signal recording surface 12a to be passed through the second objective lens 33. Then, after being converted into the P-wave by the second quarter-wavelength plate 42, the light beam B2 is reflected by the mirror 43 to output to the polarization beam splitter 35.

The light beam having the first wavelength, which is converted into the P-wave by the second quarter-wavelength plate 42, is reflected by the polarization beam splitter 35 to output to the condensing lens 39.

After the divergence angle is converted by the condensing lens 39 and the astigmatism for focus servo is imparted by the multi-lens 40, the light beam having the first wavelength reflected by the polarization beam splitter 35 is focused on the photodetection device of the photodetector 38.

As described above, the optical pickup 3 according to an embodiment of the present invention is capable of collecting light on the signal recording surface of each of the optical discs 11 and 12, which includes the protective substrate having a different thickness. Therefore, the optical pickup 3 can correct the spherical aberration due to an error in thickness of the protective substrate of each of the optical discs in a good manner. Accordingly, the optical pickup 3 according to the present invention realizes the compatibility with a plurality of types of optical discs using the same wavelength, each including a protective substrate having a different thickness.

The optical pickup 3 includes: the first objective lens 32 and the second objective lens 33, each for eliminating the spherical aberration in accordance with the thickness of the protective substrate; the polarization beam splitter 35 for guiding the light beam toward the first objective lens 32 or the second objective lens 33 depending on the polarized state; and the polarization switching section 34 for switching the polarized state of the light beam incident on the polarization beam splitter 35. With this configuration, the optical components between the light source section 31 and the polarization beam splitter 35 can be shared to realize the simplification and the reduction in size of the configuration.

Furthermore, the optical pickup 3 further includes: the first quarter-wavelength plate 41 provided between the polarization beam splitter 35 and the first objective lens 32; and the second quarter-wavelength plate 42 provided between the polarization beam splitter 35 and the second objective lens 33. The polarization beam splitter 35 guides the return light of the light beam collected by the first objective lens 32 or the second objective lens 33, which is reflected off the optical disc, toward the photodetector 38. As a result, the optical components between the polarization beam splitter 35 and the photodetector 38 can be shared to realize further simplification and reduction in size of the configuration.

The optical pickup 3 according to an embodiment of the present invention uses the light beam having a predetermined wavelength emitted from the light source section 31 to correct the spherical aberration in a good manner for the plurality of types of optical discs 11 and 12, each including the protective substrate having a different thickness, to realize signal reading and writing. At the same time, the optical pickup 3 allows the optical components and the optical paths to be shared. As a result, the optical pickup 3 according to the present invention makes it possible to simplify and reduce the size of the configuration to lower manufacture cost.

Although the light beam having the same wavelength is used as recording/reproducing light to perform recording and/or reproducing for the first and second optical discs 11 and 12, each including the protective substrate having a different thickness, in the optical pickup 3, the present invention is not limited thereto. For example, in addition to the first and second optical discs 11 and 12, the recording and/or reproducing may be performed for a plurality of types of optical discs using light beams having different wavelengths as recording/reproducing light.

Next, an optical pickup 50 shown in FIG. 2, which performs recording and/or reproducing for optical discs using the light beam having the same wavelength as recording/reproducing light, each including a protective substrate having a different thickness, and an optical disc using a light beam having a different wavelength as recording/reproducing light, will be described. In the following description, the same components as those of the optical pickup 3 described above are denoted by the same reference numerals, and the detailed description thereof is herein omitted.

The optical pickup 50 performs recording and/or reproducing on/from a plurality of optical discs, each including a protective substrate having a different thickness for protecting the signal recording surface. Specifically, the description will be given, assuming that the optical pickup 50 records or reproduces an information signal on/from the first optical disc 11 and the second optical disc 12 described above, and a third optical disc 13 and a fourth optical disc 14; the third optical disc 13 includes a third protective substrate having a second thickness of about 0.6 mm and uses a light beam having a second wavelength of about 655 nm as recording/reproducing light; and the fourth optical disc 14 includes a fourth protective substrate having a third thickness of about 1.2 mm and uses a light beam having a third wavelength of about 785 nm as recording/reproducing light.

The optical pickup 50 according to an embodiment of the present invention includes, as illustrated in FIG. 2: a light source section 51 including a first emission part for emitting a light beam having the first wavelength of about 405 nm, a second emission part for emitting a light beam having the second wavelength of about 655 nm, and a third emission part for emitting a light beam having the third wavelength of about 785 nm; the first objective lens 32 for collecting the light beam having the first wavelength on the signal recording surface 11a of the first optical disc 11 while eliminating the spherical aberration in accordance with the protective substrate having the first thickness; a second objective lens 53 for collecting the light beams having the first and second wavelengths on the signal recording surface 12a of the second optical disc 12 and a signal recording surface 13a of the third optical disc 13 while reducing or eliminating a spherical aberration in accordance with the protective substrate having the second thickness and for collecting the light beam having the third wavelength on a signal recording surface 14a of the fourth optical disc 14 while reducing or eliminating a spherical aberration in accordance with the protective substrate having the third thickness; the polarization switching section 34 for selectively switching a polarized state of the light beam emitted from each of the first to third emission parts; and the polarization beam splitter 35 for guiding the light beam to either the first or second objective lenses 32 and 53 based on the polarized state of the light beam, which is switched by the polarization switching section 34.

The optical pickup 50 also includes: the collimator lens 36 provided between the light source section 51 and the polarization switching section 34, for converting divergence angles of the light beams emitted from the first to third emission parts into approximately parallel light beams; the grating 37 provided between the light source section 51 and the collimator lens 36, for splitting the light beam into three beams composed of a 0-th order light beam and ± first order light beams so as to obtain a tracking error signal and the like; the photodetector 38 for receiving return light reflected by the signal recording surface; the condensing lens 39 provided between the polarization beam splitter 35 and the photodetector 38, for condensing the passing light beam on the photodetector 38; and the multi-lens 40 provided between the polarization beam splitter 35 and the photodetector 38, for generating an astigmatism to obtain a focusing error signal.

The optical pickup 50 further includes: the mirror 43 for reflecting the light beam passed through the polarization beam splitter 35 to change an optical path of the light beam so as to guide the light beam to the second objective lens 53; the first quarter-wavelength plate 41 provided between the polarization beam splitter 35 and the first objective lens 32 to impart a phase difference of a quarter wavelength to the light beam reflected by the polarization beam splitter 35; and the second quarter-wavelength plate 42 provided between the mirror 43 and the second objective lens 53 to impart a phase difference of a quarter wavelength to the light beam reflected by the mirror 43.

The light source section 51 switches the light beam to be emitted based on the type of disc detected by the disc type determining section 22. Specifically, when the loaded optical disc 2 is the first optical disc 11 or the second optical disc 12, the light source section 51 emits the light beam having the first wavelength from the first emission part. When the optical disc 2 is the third optical disc 13, the light source section 51 emits the light beam having the second wavelength from the second emission part. When the optical disc 2 is the fourth optical disc 14, the light source section 51 emits the light beam having the third wavelength from the third emission part.

Although the first to third emission parts respectively for emitting the light beams having the first to third wavelengths are provided for a single light source section in this embodiment, the present invention is not limited thereto. For example, a first light source section including two of the first to third emission parts and a second light source section including the other one emission part may be arranged at different locations. Alternatively, the first to third emission parts may be arranged at different locations. In this case, a beam splitter or the like may be provided as optical path combining means for combining optical paths of the light sources arranged at different locations to combine the optical paths.

The second objective lens 53 has the second focal length to correspond to the light beams having the first to third wavelengths and a numerical aperture of 0.65 for the first or second wavelength and 0.45 for the third wavelength. For the second optical disc 12 including the second protective substrate having the second thickness, the second objective lens 53 collects the light beam having the first wavelength on the signal recording surface 12a while reducing or eliminating a spherical aberration in accordance with the second protective substrate.

For the third optical disc 13 including the third protective substrate having the second thickness, the second objective lens 53 collects the light beam having the second wavelength on the signal recording surface 13a while reducing or eliminating a spherical aberration in accordance with the third protective substrate. For the fourth optical disc 14 including the fourth protective substrate having the third thickness, the second objective lens 53 collects the light beam having the third wavelength on the signal recording surface 14a while reducing or eliminating a spherical aberration in accordance with the fourth protective substrate.

On the light-incoming side of the second objective lens 53, the second aperture filter (not shown) serving as an aperture limiting element for limiting the aperture of the light beam incident on the second objective lens 53 is provided. The second aperture filter limits the numerical aperture of the passing light beams having the first and second wavelengths to 0.65 and the numerical aperture of the passing light beam having the third wavelength to 0.45. As the aperture filter, for example, a hologram or the like is used.

The polarization switching section 34 is composed of, as in the case of the optical pickup 3 described above, the polarization switching liquid crystal 34a and the liquid crystal driving circuit 34b. The polarization switching section 34 selectively switches a polarized state of the passing light beam based on the type of disc detected by the disc type determining section 22. Specifically, when the loaded optical disc 2 is the first disc 11, the polarization switching liquid crystal 34a of the polarization switching section 34 is turned ON by the liquid crystal driving circuit 34b to convert the polarized state of the passing light beam having the first wavelength from a S-wave to a P-wave so as to allow the light beam to outgo. On the other hand, when the loaded disc 2 is any one of the second disc 12, the third disc 13 and the fourth disc 14, the polarization switching liquid crystal 34a of the polarization switching section 34 is made to remain in the OFF state by the liquid crystal driving circuit 34b to allow the passing light beam having the first wavelength to outgo as the S-wave.

The optical pickup 50 configured as described above drives the first objective lens 32 or the second objective lens 53 based on the focusing servo signal and the tracking servo signal generated by the return light detected by the photodetector 38 to perform focus servo and tracking servo. The first objective lens 32 or the second objective lens 53 is driven to be moved to a focused focal point of the objective lens with respect to the recording face of the optical disc 2. As a result, the light beam is focused on the recording face of the optical disc 2 to record or reproduce information on/from the optical disc 2.

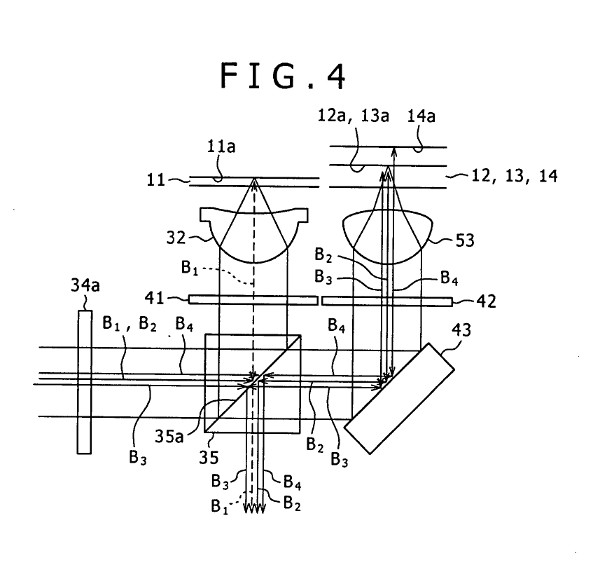

Next, the optical path of the light beam emitted from the light source section 51 in the optical pickup 50 will be described with reference to FIGS. 2 and 4. First, the optical path of the light beam having the first wavelength emitted to the first optical disc 11 will be described.

The optical path of the light beam having the first wavelength emitted to the first optical disc 11 is the same as that of the light beam having the first wavelength emitted to the first optical disc 11 in the optical pickup 3 described above. Specifically, based on a detected signal from the disc type determining section 22 which has determined that the optical disc 2 is the first optical disc 11, the light beam B1 having the first wavelength emitted from the first emission part of the light source section 51 passes through the grating 37, the collimator lens 36, the polarization switching liquid crystal 34a, the polarization beam splitter 35 and the first quarter-wavelength plate 41 to be collected by the first objective lens 32 on the signal recording surface 11a of the first optical disc 11 with the spherical aberration in accordance with the first thickness of the first protective substrate being eliminated or substantially reduced. The outgoing light beam B1, which is collected on the first optical disc 11 and reflected by the signal recording surface 11a, passes through the first objective lens 32, the first quarter-wavelength plate 41, the polarization beam splitter 35, the condensing lens 39 and the multi-lens 40 to be focused on the photodetection device of the photodetector 38.

Next, the optical path of the light beam having the first wavelength emitted to the second optical disc 12 in the optical pickup 50 will be described.

The optical path of the light beam having the first wavelength emitted to the second optical disc 12 is the same as that of the light beam having the first wavelength emitted to the second optical disc 12 in the optical pickup 3 described above. Specifically, based on a detected signal from the disc type determining section 22, which has determined that the optical disc 2 is the second optical disc 12, the light beam B2 having the first wavelength emitted from the first emission part of the light source section 51 passes through the grating 37, the collimator lens 36, the polarization switching liquid crystal 34a, the polarization beam splitter 35, the mirror 43 and the second quarter-wavelength plate 42. Furthermore, the light beam B2 is condensed by the second objective lens 53 on the signal recording surface 12a of the second optical disc 12 with the spherical aberration in accordance with the second protective substrate having the second thickness being eliminated or substantially reduced. The outgoing light beam B2, which is collected on the second optical disc 12 and reflected by the signal recording surface 12a, passes through the second objective lens 53, the second quarter-wavelength plate 42, the mirror 43, the polarization beam splitter 35, the condensing lens 39 and the multi-lens 40 to be focused on the photodetection device of the photodetector 38.

The optical path of the light beam having the second wavelength emitted to the third optical disc 13 in the optical pickup 50 is the same as that of the light beam having the first wavelength emitted to the second optical disc 12 described above. Specifically, based on a detected signal from the disc type determining section 22 which has determined that the optical disc 2 is the third optical disc 13, a light beam B3 having the second wavelength emitted from the second emission part of the light source section 51 passes through the grating 37, the collimator lens 36, the polarization switching liquid crystal 34a, the polarization beam splitter 35, the mirror 43 and the second quarter-wavelength plate 42 to be collected by the second objective lens 53 on the signal recording surface 13a of the third optical disc 12 with the spherical aberration in accordance with the third protective substrate having the second thickness being eliminated or substantially reduced. The outgoing light beam B3, which is collected on the third optical disc 13 and reflected by the signal recording surface 13a, passes through the second objective lens 53, the second quarter-wavelength plate 42, the mirror 43, the polarization beam splitter 35, the condensing lens 39 and the multi-lens 40 to be focused on the photodetection device of the photodetector 38.

The optical path of the light beam having the third wavelength emitted to the fourth optical disc 14 in the optical pickup 50 is the same as that of the light beam having the first wavelength emitted to the second optical disc 12 described above. Specifically, based on a detected signal from the disc type determining section 22 which has determined that the optical disc 2 is the fourth optical disc 14, the light beam B4 having the third wavelength emitted from the third emission part of the light source section 51 passes through the grating 37, the collimator lens 36, the polarization switching liquid crystal 34a, the polarization beam splitter 35, the mirror 43 and the second quarter-wavelength plate 42 to be collected by the second objective lens 53 on the signal recording surface 14a of the fourth optical disc 14 with the spherical aberration in accordance with the fourth protective substrate having the third thickness being eliminated or substantially reduced. The outgoing light beam B4, which is collected on the fourth optical disc 14 and then reflected by the signal recording surface 14a, passes through the second objective lens 53, the second quarter-wavelength plate 42, the mirror 43, the polarization beam splitter 35, the condensing lens 39 and the multi-lens 40 to be focused on the photodetection device of the photodetector 38.

As described above, the optical pickup 50 according to the present embodiment is capable of appropriately collecting light on the signal recording surface of each of the optical discs 11 to 14, each including the protective substrate having a different thickness. Therefore, the optical pickup 50 can correct the spherical aberration due to an error in thickness of the protective substrate of each of the optical discs in a good manner, thereby realizing the compatibility with a plurality of types of optical discs, each including the protective substrate having a different thickness.

The optical pickup 50 includes: the first objective lens 32 and the second objective lens 53, each for eliminating the spherical aberration in accordance with the thickness of the protective substrate; the polarization beam splitter 35 for guiding the light beam toward the first objective lens 32 or the second objective lens 53 depending on the polarized state of the light beam; and the polarization switching section 34 for switching the polarized state of the light beam incident on the polarization beam splitter 35. With this configuration, the optical components between the light source section 51 and the polarization beam splitter 35 can be shared to realize the simplification and the reduction in size of the configuration.

The optical pickup 50 further includes: the first quarter-wavelength plate 41 provided between the polarization beam splitter 35 and the first objective lens 32; and the second quarter-wavelength plate 42 provided between the polarization beam splitter 35 and the second objective lens 53. The polarization beam splitter 35 guides the return light of the light beam collected by the first objective lens 32 or the second objective lens 53, which is reflected off the optical disc, toward the photodetector 38. As a result, the optical components between the polarization beam splitter 35 and the photodetector 38 can be shared to realize further simplification and reduction in size of the configuration.

The optical pickup 50 according to the present embodiment uses the light beams having different wavelengths emitted from the light source section 51 to realize signal reading from and writing to the plurality of types of optical discs 11 to 14, each including the protective substrate at a different thickness, while correcting the spherical aberration in a good manner. At the same time, the optical pickup 50 allows the optical components and the optical paths to be shared. As a result, the optical pickup 50 according to the present invention makes it possible to simplify and reduce the size of the configuration to lower manufacture cost.

Furthermore, the optical pickup 50 according to the present embodiment is capable of realizing signal reading from and writing to a plurality of types of optical discs using the same wavelength, each including a protective substrate having a different thickness, in addition to a plurality of types of optical discs using different wavelengths, each including a protective substrate having a different thickness. Therefore, the optical pickup 50 realizes the compatibility with optical discs in a plurality of types of formats which are being further diversified. At the same time, the optical pickup 50 realizes the reduction in size of the configuration.

The optical disc apparatus 1 using the optical pickup according to the present embodiment includes the above-described optical pickup 3 or 50 so that the optical components and the optical paths of the optical pickup are shared for a plurality of optical discs, each including a protective substrate having a different thickness, to enable good signal recording and reproducing. Therefore, the optical disc apparatus 1 has excellent compatibility to correspond to a plurality of types of optical disc and also realizes the simplification and the reduction in size of the configuration, thereby lowering manufacture cost.

The present invention contains subject matter related to Japanese Patent Application JP 2005-182512 filed in the Japanese Patent Office on Jun. 22, 2005, the entire contents of which being incorporated herein by reference.

It should be understood by those skilled in the art that various modifications, combinations, sub-combinations and alterations may occur depending on design requirements and other factors insofar as they are within the scope of the appended claims or the equivalents thereof.

1. An optical pickup for recording or reproducing an information signal on/from a plurality of optical discs, each including a protective substrate having a different thickness for protecting a signal recording surface, the optical pickup comprising:
a light source section adapted to emit a light beam having a predetermined wavelength;
a first objective lens adapted to collect light on the signal recording surface while reducing a spherical aberration due to a protective substrate having a first thickness;
a second objective lens adapted to collect light on the signal recording surface while reducing a spherical aberration due to a protective substrate having a second thickness;
a polarization switching section adapted to switch a polarized state of the light beam emitted from the light source section; and
a polarization beam splitter adapted to guide the light beam to either the first objective lens or the second objective lens depending on the polarized state of the light beam switched by the polarization switching section.

2. The optical pickup according to claim 1, further comprising:
a first quarter-wavelength plate provided between the first objective lens and the polarization beam splitter; and
a second quarter-wavelength plate provided between the second objective lens and the polarization beam splitter.

3. The optical pickup according to claim 1, further comprising:
a photodetector adapted to detect return light reflected off an optical disc of the plurality of optical discs;
wherein the polarization beam splitter separates return light of the light beam collected by either the first or second objective lenses from an optical path of the light beam emitted from the light source, the return light being reflected off the optical disc.

4. An optical pickup for recording or reproducing an information signal on/from a plurality of optical discs, each including a protective substrate having a different thickness for protecting a signal recording surface, with light beams having different wavelengths, the optical pickup comprising:
a light source section including a first light source adapted to emit a light beam having a first wavelength, a second light source adapted to emit a light beam having a second wavelength, and a third light source adapted to emit a light beam having a third wavelength;
a first objective lens adapted to collect the light beam having the first wavelength on the signal recording surface while reducing a spherical aberration due to a protective substrate having a first thickness;
a second objective lens adapted to collect the light beams having the first wavelength and the second wavelength on the signal recording surface while reducing a spherical aberration due to a protective substrate having a second thickness, and to collect the light beam having the third wavelength on the signal recording surface while reducing a spherical aberration due to a protective substrate having a third thickness;
a polarization switching section adapted to switch a polarized state of each of the light beams emitted from the first to third light sources; and
a polarization beam splitter adapted to guide the light beam to either the first objective lens or the second objective lens depending on the polarized state of the light beam switched by the polarization switching section.

5. The optical pickup according to claim 4, further comprising:
a disc type determination section adapted to distinguish types of the plurality of optical discs,
wherein the polarization switching section includes a polarization switching liquid crystal section and a liquid crystal driving circuit, and selectively switches a polarized state of the light beam emitted from the light source section based on the type of disc determined by the disc type determining section.

6. The optical pickup according to claim 4, wherein:
a thin optical film having a polarization dependency that transmits an S-wave component of the light beam emitted from the light source section and reflects a P-wave component thereof is formed in the polarization beam splitter;
the polarization switching section selectively switches the polarized state of the passing light beam to the P-wave component if the light beam is to be guided to the first objective lens; and
the polarization switching section selectively switches the polarized state of the passing light beam to the S-wave component if the light beam is to be guided to the second objective lens.

7. An optical disc apparatus including driver means for holding and rotating an optical disc, and an optical pickup for recording or reproducing an information signal on/from a plurality of the optical discs, each including a protective substrate having a different thickness for protecting a signal recording surface, the optical disc apparatus comprising:
a light source section adapted to emit a light beam having a predetermined wavelength;
a first objective lens adapted to collect light on the signal recording surface while reducing a spherical aberration due to a protective substrate having a first thickness;
a second objective lens adapted to collect light on the signal recording surface while reducing a spherical aberration due to a protective substrate having a second thickness;
a polarization switching section adapted to switch a polarized state of the light beam emitted from the light source section; and
a polarization beam splitter adapted to guide the light beam to either the first objective lens or the second objective lens depending on the polarized state of the light beam switched by the polarization switching section.

8. An optical disc apparatus including driver means for holding and rotating an optical disc, and an optical pickup for recording or reproducing an information signal on/from a plurality of the optical discs, each including a protective substrate having a different thickness for protecting a signal recording surface, the optical disc apparatus comprising:
a light source section including a first light source adapted to emit a light beam having a first wavelength, a second light source adapted to emit a light beam having a second wavelength, and a third light source adapted to emit a light beam having a third wavelength;
a first objective lens adapted to collect the light beam having the first wavelength on the signal recording surface while reducing a spherical aberration due to a protective substrate having a first thickness;
a second objective lens adapted to collect the light beams having the first wavelength and the second wavelength on the signal recording surface while reducing a spherical aberration due to a protective substrate having a second thickness, and to collect the light beam having the third wavelength on the signal recording surface while reducing a spherical aberration due to a protective substrate having a third thickness;
a polarization switching section adapted to switch a polarized state of each of the light beams emitted from the first to third light sources; and
a polarization beam splitter adapted to guide the light beam to either the first objective lens or the second objective lens depending on the polarized state of the light beam switched by the polarization switching section.
